(19) United States
(12) Patent Application Publication
(10) Pub. No.: US 2026/0148416 A1
(43) Pub. Date: May 28, 2026

(54) PROCESSING METHOD AND ELECTRONIC DEVICE

(71) Applicant: Lenovo (Beijing) Limited, Beijing (CN)

(72) Inventor: Liang ZHANG, Beijing (CN)

(21) Appl. No.: 19/390,098

(22) Filed: Nov. 14, 2025

(30) Foreign Application Priority Data
Nov. 22, 2024 (CN) 202411691062.1

(51) Int. Cl. G06T 7/73; G06F 3/04842; G06T 7/194

(52) U.S. Cl. CPC G06T 7/74; G06F 3/04842; G06T 7/194; G06T 2200/24; G06T 2207/20132

(57) ABSTRACT

A processing method includes obtaining a first position of a target display object displayed within a target area, and determining, in response to an electronic device satisfying a condition, a second position of the target display object within the target area based on the condition and the first position. The first position is different from the second position, and the condition includes a pose change condition. The method further includes displaying the target display object based on the target area and the second position.

### CROSS-REFERENCE TO RELATED APPLICATION

This application claims priority to Chinese Patent Application No. 202411691062.1, filed on Nov. 22, 2024, the entire content of which is incorporated herein by reference.

### TECHNICAL FIELD

The present disclosure generally relates to the field of data processing technologies, and, more particularly, to a processing method and an electronic device.

### BACKGROUND

An electronic device can display various objects in any area of its display screen. For example, a mobile phone can use its entire display area to display a photo including a person or another object.

When an electronic device displays an image frame in a target area, an object in the image is always displayed at a specific position within the target area. This display method cannot meet the needs of some users.

### SUMMARY

In accordance with the disclosure, there is provided a processing method including obtaining a first position of a target display object displayed within a target area, and determining, in response to an electronic device satisfying a condition, a second position of the target display object within the target area based on the condition and the first position. The first position is different from the second position, and the condition includes a pose change condition. The method further includes displaying the target display object based on the target area and the second position.

Also in accordance with the disclosure, there is provided an electronic device including a detection module, a processing module, and a display screen. The detection module is configured to detect whether the electronic device satisfies a condition. The processing module is configured to obtain a first position of a target display object displayed within a target area of the display screen, and determine, in response to the electronic device satisfying a condition, a second position of the target display object within the target area based on the condition and the first position. The first position is different from the second position, and the condition includes a pose change condition. The processing module is further configured to display the target display object based on the target area and the second position.

Also in accordance with the disclosure, there is provided a non-transitory computer-readable storage medium storing program instructions that, when executed by a processor, cause an electronic device including the processor to obtain a first position of a target display object displayed within a target area, and determine, in response to the electronic device satisfying a condition, a second position of the target display object within the target area based on the condition and the first position. The first position is different from the second position, and the condition includes a pose change condition. The program instructions further cause the electronic device to display the target display object based on the target area and the second position.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work. Throughout the drawings, the same or similar reference numerals represent the same or similar elements. It should be understood that the drawings are schematic and that the originals and elements are not necessarily drawn to scale.

FIG. 1 is a flowchart of a processing method consistent with embodiments of the present disclosure.

FIG. 2 is a schematic diagram showing a display interface consistent with embodiments of the present disclosure.

FIG. 3 is a schematic diagram showing another display interface consistent with embodiments of the present disclosure.

FIG. 4 is a schematic diagram showing obtaining a second image consistent with embodiments of the present disclosure.

FIG. 5 is another schematic diagram showing obtaining a second image consistent with embodiments of the present disclosure.

FIG. 6 is a schematic diagram showing processing a target display object in a plurality of consecutive moments consistent with embodiments of the present disclosure.

FIG. 7 is a schematic structural diagram of an electronic device consistent with embodiments of the present disclosure.

### DETAILED DESCRIPTION OF THE EMBODIMENTS

Various schemes and features of the present disclosure are described herein with reference to the accompanying drawings. The terms used in the present disclosure are only used to explain the specific embodiments of the present disclosure and are not intended to limit the scope of the present disclosure. It is understandable to those skilled in the art that with the development of technology and the emergence of new scenarios, the technical solutions provided in the embodiments of the present disclosure are also applicable to similar technical problems.

The terms “first/second/third” involved in the present disclosure are only used to distinguish similar objects, and do not represent a specific order for the objects. It is understood that objects described by “first/second/third” can be interchanged with a specific order or sequence where permitted, such that the embodiments of the present disclosure described here can be implemented in an order other than that illustrated or described here. The terms “including,” “comprising,” or “having,” and any variations thereof, are intended to cover a non-exclusive inclusion, such that a process, method, system, product, or apparatus that comprises a list of elements is not necessarily limited to those elements but may include other elements not expressly listed or inherent to such process, method, product, or device. Unless otherwise defined, all technical and scientific terms used in the present disclosure have the same meaning as those generally understood by those skilled in the art. The terms used in the present disclosure are only for the purpose of description and are not intended to limit the scope of the present disclosure.

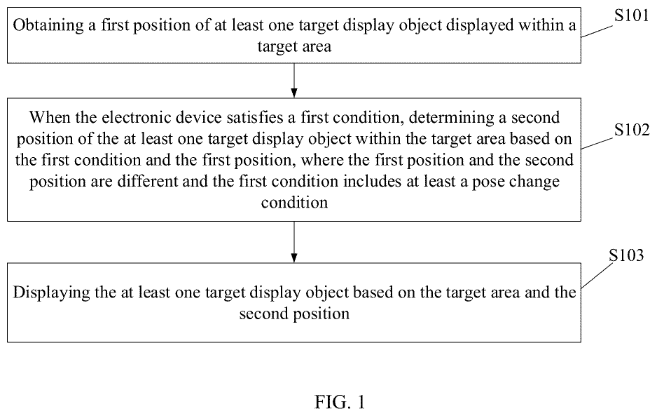

The present disclosure provides a processing method, applicable to an electronic device. As shown in FIG. 1, in one embodiment, the method includes S101 to S103.

At S101, a first position of at least one target display object displayed in a target area is obtained.

In the present embodiment, the target area may be an entire display area or a part of the display area of a display screen in the electronic device.

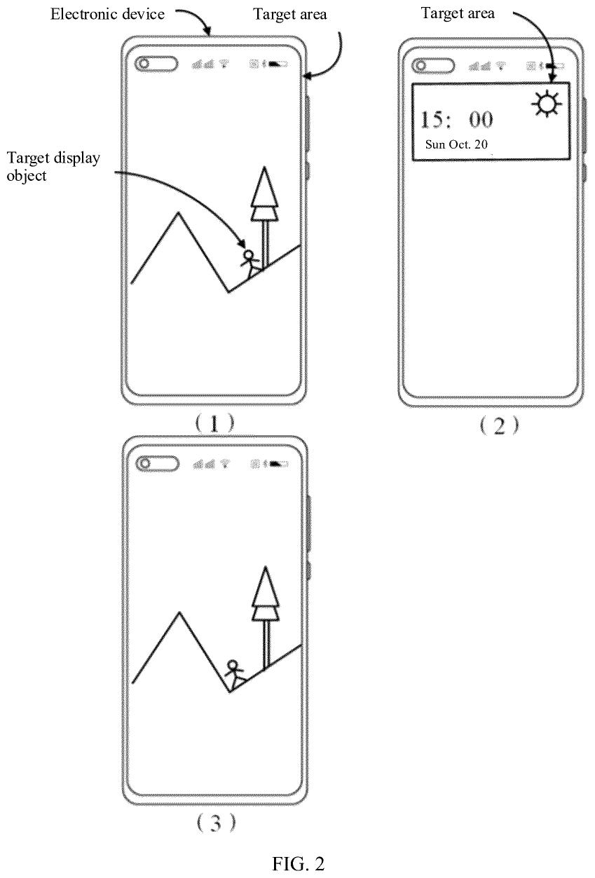

As an example, as shown in FIG. 2, the target area may include the entire display area of the display screen as shown in part (1) of FIG. 2 or may only include the display area within the rectangular frame in the display screen as shown in part (2) of FIG. 2.

The electronic device may continuously display an image in the target area, or may display several images one by one in the target area at a plurality of consecutive moments. The latter may correspond to a scene in which the electronic device plays a video or displays a dynamic image in the target area.

For any image displayed by the electronic device in the target area, the at least one target display object may include any one or more display objects included in the image. In combination with the above examples, the at least one target display object may include the character object shown in part (1) of FIG. 2.

In this embodiment, an image displayed in the target area before determining that the electronic device meets a first condition may be denoted as a first image.

The first position may include the position of the at least one target object in the target area at the current moment (i.e., when executing S101).

In this embodiment, each time the electronic device displays an image within the target area, it may execute S101 to obtain the first position of the at least one target object within that image.

For example, when the electronic device is in an off-screen state, the display screen may not display image content. At a certain moment, in response to a specific wake-up condition (such as a user tapping the display screen or pressing the lock screen key), the electronic device may switch from the off-screen state to the on-screen state. At this time, the electronic device may display a frame of wallpaper image across the entire display area of the display screen. While displaying this image, the electronic device may execute S101 to obtain the first position of the at least one target display object within the display area of the wallpaper image.

As another example, when the electronic device runs a video application, it may display a playback window in a specific area of the display screen and play video content within the playback window. In this case, the electronic device may use the playback window area as the target area. Each time a video frame is displayed within the playback window, the electronic device may obtain the positions of the one or more display objects within the playback window area as the first position.

At S102, when the electronic device meets the first condition, a second position of the at least one target display object within the target area is determined based on the first condition and the first position, where the first position and the second position are different and the first condition at least includes a pose change condition.

In this embodiment, after displaying an image in the target area, the electronic device may periodically detect in real time whether it meets the first condition. If the first condition is met, S102 may be executed. If not, the electronic device may continue to display the image in the target area in its original display mode.

In some embodiments, the electronic device may also first display the image in the target area and then detect in real time whether it meets the first condition. Only after detecting that the first condition is met, S101 and S102 may be executed sequentially to obtain the first position and determine the second position based on the first condition and the first position.

The first condition may include at least the pose change condition. That is, the electronic device may obtain its own pose parameters in every detection cycle. S102 may only be performed when, based on the pose parameters, it is determined that the current pose changes relative to the pose of the previous detection cycle, and the change satisfies a specific condition.

In some examples, the pose change condition may include a pose change magnitude larger than a certain threshold. For example, the pose change condition may include the electronic device's rotation angle larger than a specific angle threshold, or the electronic device's displacement distance larger than a specific distance threshold.

In other examples, the pose change condition may include a pose change direction in a specific direction. For example, the pose change condition may include the electronic device rotating clockwise about the vertical axis of symmetry of the display screen, or the electronic device may move horizontally to the right or left.

When the electronic device meets the first condition, the electronic device may determine the second position based on at least the pose change condition and the first position. For example, the second position may be determined based on at least the pose change magnitude and the first condition, or based on the pose change direction and the first position, or based on the pose change magnitude, the pose change direction, and the first position.

At S103, the at least one target display object is displayed based on the target area and the second position.

At S103, the electronic device may adjust the image displayed in the target area and then display the adjusted image. In the adjusted image, the at least one target display object may be located at the second position in the target area.

As an example, before determining that the electronic device meets the first condition, the electronic device may display the image shown in part (1) of FIG. 2 in the display area of the display screen, where the at least one target display object is at the first position shown in the figure. After determining that the electronic device meets the first condition, the electronic device may display the adjusted image shown in FIG. 2(3) in the display area of the display screen. It can be seen that the at least one target display object in FIG. 2(3) is at the second position, different from that in part (1) of FIG. 2.

In the present embodiment, the electronic device may adjust the position of the at least one target display object displayed in the target area at least when the electronic device undergoes a pose change and meets a specific pose change condition. When at least the pose change condition is met, the at least one target display object may be displayed based on the adjusted second position. Thus, when the pose change condition is met, the electronic device may present a visual effect of the at least one target display object moving with the pose change of the electronic device in the target area, thereby meeting the usage needs of some users in some scenarios.

In some optional embodiments, when the electronic device adjusts the at least one target display object from the first position to the second position, a position of a background image of the target area within the target area may remain unchanged., allowing the first relative position and the second relative position of the at least one target display object to differ, thereby creating a visual effect of displacement of the at least one target display object relative to the background image of the target area when the electronic device satisfies at least the pose change condition.

Before determining that the electronic device satisfies the first condition, the image displayed by the electronic device within the target area may be considered as the first image, and the first image may include the at least one target display object. The background image of the target area may include the background image excluding the at least one target display object in the first image.

Correspondingly, the first relative position of the at least one target display object may be the relative position of the at least one target display object relative to the background image excluding the at least one target display object in the first image when the electronic device displays the at least one target display object based on the first position (equivalent to before determining that the first condition is satisfied).

The second relative position of the at least one target display object may be the relative position of the at least one target display object relative to the background image when the electronic device displays the at least one target display object based on the second position (equivalent to after determining that the first condition is satisfied).

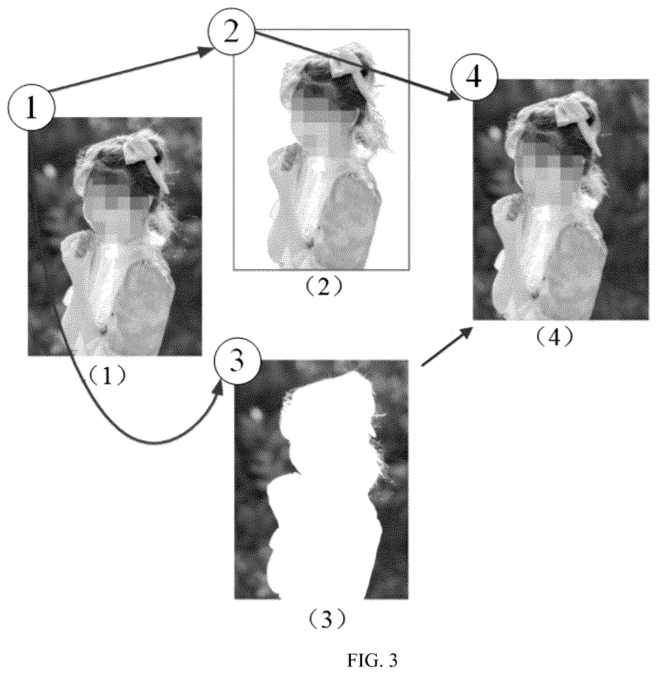

As an example, before determining that the first condition is met, the first image displayed by the electronic device in the target area may be the image shown in part (1) of FIG. 3, where the at least one target display object may be shown in of part (2) of FIG. 3, and the background image other than the at least one target display object may be shown in part (3) of FIG. 3.

In some optional embodiments, after determining that the first condition is met, the electronic device may adjust the at least one target display object from the first position to the second position, or may adjust the position of the background image of the target area and then display the background image in the adjusted position and the at least one target display object in the second position in the target area, where the amplitude of the position adjustment of the background image and the amplitude of the position adjustment of the at least one target display object are different, thereby presenting a visual effect that the at least one target display object moves to the left relative to the background. Exemplarily, the image shown in part (4) of FIG. 3 may be displayed based on the background image and the at least one target display object after the position adjustment. Comparing part (1) of FIG. 3 and part (4) of FIG. 3, it may be seen that the at least one target display object moves horizontally to the left by a certain distance relative to the background image, thereby presenting a visual effect that the at least one target display object moves to the left relative to the background.

For example, the horizontal distance between the first position and the second position of the at least one target display object may be x1, and the horizontal distance between the third position of the background image before adjustment in the target area and the fourth position of the background image after adjustment may be x2, where x2 may be larger than 0 and less than x1.

Using the above method, the first relative position and the second relative position of the at least one target display object may be adjusted to be different from each other, thereby creating a visual effect of the at least one target display object being displaced relative to the background image.

In some embodiments, after determining that the first condition is met, the electronic device may not change the position of the background image. That is, the electronic device may display the at least one target display object based on the second position within the target area, while displaying the background image based on its original position before the first condition was met.

Alternatively, the first condition may include only the pose change condition, or may include the pose change condition and other additional conditions.

In some examples, the first condition may include both a pose change condition and a brightness condition. Correspondingly, upon determining that the pose change condition is met, the electronic device may determine the second position of the at least one target display object based on the pose change condition and the first position, and determine the target brightness of the at least one target display object and the background image based on the brightness condition. The at least one target display object may then be displayed within the target area based on the second position and the target brightness.

The brightness condition may include the brightness of the electronic device's environment. In this example, when the brightness of the environment is high, a higher target brightness may be determined, and when the brightness of the environment is low, a lower target brightness may be determined.

In some examples, the first condition may include both the pose change condition and the temperature condition. Correspondingly, upon determining that the pose change condition is met, the electronic device may determine the second position of the at least one target display object based on the pose change condition and the first position, determine a target color temperature for the at least one target display object and the background image based on the temperature condition, and display the at least one target display object within the target area based on the second position and the target color temperature.

The temperature condition may include the temperature of the electronic device's environment. In this example, when the ambient temperature is high, a higher target color temperature may be determined, and when the ambient temperature is low, a lower target color temperature may be determined.

In some examples, the first condition may include a pose change condition and a humidity condition. Correspondingly, upon determining that the pose change condition is met, the electronic device may determine the second position of the at least one target display object based on the pose change condition and the first position, determine a target blurriness for the at least one target display object and the background image based on the humidity condition, and display the at least one target display object within the target area based on the second position and the target blurriness.

The humidity condition may include the humidity of the electronic device's environment. In this example, when the ambient humidity is high, a higher target blurriness may be determined, resulting in a blurrier display of the at least one target display object and the background image, and when the ambient humidity is low, a lower target blurriness may be determined, resulting in a clearer display of the at least one target display object and the background image.

In some optional embodiments, the second position may be determined by:
when the first condition includes the pose change condition, determining a displacement parameter of the at least one target display object based on a first pose of the electronic device before the change and a second pose of the electronic device after the change; and
determining the second position of the at least one target display object within the target area based on the displacement parameter and the first position.

The displacement parameter of the at least one target display object may include the displacement direction and displacement amplitude of the at least one target display object.

The displacement direction of the at least one target display object may be determined based on the pose change direction of the electronic device. The pose change direction of the electronic device and the displacement direction of the at least one target display object may be the same as or opposite to each other.

As some examples, assuming that the electronic device changes from a first pose to a second pose by moving horizontally to the left by a certain distance, i.e., the pose change direction is horizontal leftward movement, the at least one target display object's displacement direction may be determined to be horizontal rightward movement.

As another example, when the electronic device changes from the first pose to the second pose by swinging to the left by a certain angle about an axis perpendicular to the display screen, the displacement direction may be a horizontal rightward movement. When the pose change direction is swinging to the right by a certain angle about an axis perpendicular to the display screen, the displacement direction may be a horizontal leftward movement.

As yet another example, when the electronic device changes from the first pose to the second pose by turning the top of the display screen toward the user, the displacement direction may be vertical downward movement. When the pose change direction is turning the bottom of the display screen toward the user, the displacement direction may be vertical upward movement.

The displacement amplitude of the at least one target display object may be determined based on the pose change amplitude of the electronic device or set to a fixed value.

In one embodiment, when the displacement amplitude of the at least one target display object is determined based on the pose change amplitude of the electronic device, multiple non-overlapping change amplitude intervals may be defined, each corresponding to one displacement amplitude of the at least one target display object. A change amplitude interval with a larger upper limit may correspond to a larger displacement amplitude. After obtaining the electronic device's pose change amplitude, a displacement amplitude corresponding to the change amplitude interval within which the pose change amplitude falls may be determined as the displacement amplitude of the at least one target display object.

In another embodiment, when the displacement amplitude of the at least one target display object is determined based on the pose change amplitude of the electronic device, the electronic device's pose change amplitude may be calculated according to a certain proportional relationship or other functional relationship, and the calculated result may be used as the displacement amplitude of the at least one target display object. For example, a 6:1 ratio may be set. For every 3 cm movement of the electronic device, the displacement amplitude of the at least one target display object may be determined to be 0.5 cm, and for every 30 degrees rotation of the electronic device, the rotation amplitude of the at least one target display object may be determined to be 5 degrees.

In another embodiment, when the displacement amplitude of the at least one target display object is set to a fixed value, a fixed target movement distance and/or target rotation angle may be set. After determining the displacement direction, when movement is required, the target movement distance and displacement direction may be determined as the displacement parameter of the at least one target display object. When rotation is required, the target rotation angle and displacement direction may be determined as the displacement parameter of the at least one target display object. The target movement distance and/or target rotation angle may be pre-set by the manufacturer or customized by the user of the electronic device.

The target area may include one or more target display objects. In some embodiments, the target area may include multiple target display objects, and the electronic device may determine the second positions of each target display object in the manner described above.

In one embodiment, after determining the second position, the electronic device may display the at least one target display object based on the target area and the second position by:
cropping the first image to be displayed in the target area to obtain the at least one target display object included in the first image and the background image excluding the at least one target display object in the first image;
processing the at least one target display object and the background image based on the second position to obtain a second image including the at least one target display object; and
displaying the second image in the target area.

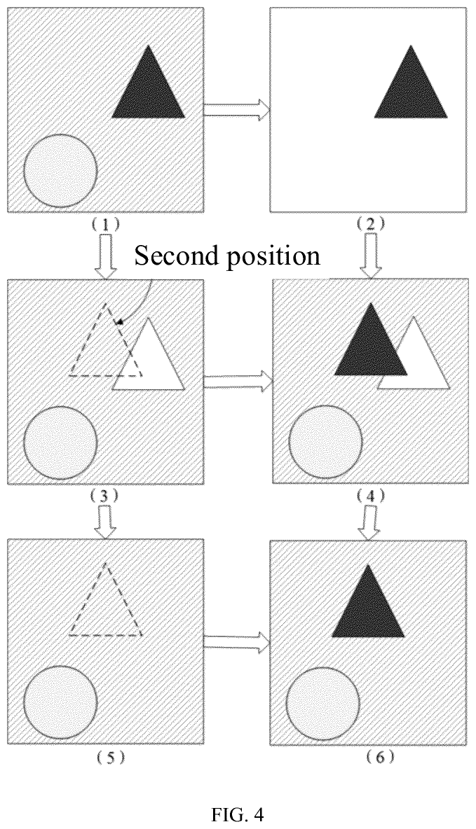

Taking FIG. 4 as an example, the electronic device may crop the first image shown in part (1) of FIG. 4 to obtain the at least one target display object shown in part (2) of FIG. 4 (which may also be regarded as the foreground of the first image) and obtain the background image of the first image excluding the at least one target display object shown in part (3) of FIG. 4.

Then, the electronic device may paste the at least one target display object to the second position in the background image and use the obtained image as the second image. For example, the at least one target display object may be pasted to the second position of the background image shown in part (3) of FIG. 4, that is, the dotted triangle area shown in the figure, and the image shown in part (4) of FIG. 4 is obtained as the second image. Among them, the dotted triangle frame in FIG. 493) is only used to indicate the second position, and the actual background image may not include this frame.

The outlines of the first image and the background image may be consistent with the outline of the target area. Therefore, the second position of the target area may be equivalent to the second position of the background image. By pasting the at least one target display object at the second position of the background image and displaying the pasted image in the target area, the visual effect of displaying the at least one target display object at the second position of the target area may be presented.

Optionally, as can be seen from part (4) of FIG. 4, the image obtained by directly pasting the at least one target display object to the second position may have a certain blank portion. Displaying the image with the blank portion may result in a poor visual effect. Therefore, processing at least one target display object and the background image according to the second position may include:
processing at least one target display object and the background image according to an intelligent engine and the second position to obtain the second image including the at least one target display object.

The intelligent engine may be used to determine the output image based on the first portion of the input image, where the first portion may at least include the pixel content of the background image, and the input image of the intelligent engine may be the background image or a fused image obtained by fusing the at least one target display object and the background image according to the second position.

The first portion may also be called the non-blank part of the input image. For any image, the blank part of the image may be understood as the part of the image that does not include any pixel content, or may be understood as the part of the image where the transparency of the pixels is 100% (completely transparent). Another part of the image other than the blank part may be called the non-blank part of the image. As an example, the white part in part (3) of FIG. 4 and part (4) of FIG. 4 may be regarded as the blank part, and the part other than the blank part may be regarded as the non-blank part.

In this embodiment, the intelligent engine may use one or more processing models based on machine learning technology, neural network technology or other image processing technology, to process the input image, generate pixel content for filling the blank part of the input image based on the non-blank part of the input image, fill these contents into the blank part of the input image, and output the filled image as the output image.

In this embodiment, obtaining the second image based on the intelligent engine may include:
processing the at least one target display object and the background image based on the second position, obtaining a fused image including the at least one target display object and the background image with the at least one target display object located at the second position in the fused image, inputting the fused image into the intelligent engine as the input image of the intelligent engine, and processing the fused image using the intelligent engine. When the intelligent engine is processing, the blank part of the fused image may be filled based on the non-blank part of the fused image. The output image of the intelligent engine may be obtained as the second image.

As an example, the fused image in the above method may be the image shown in part (4) of FIG. 4, and the output image after the intelligent engine processing may be the image shown in part (6) of FIG. 4.

The advantage of obtaining the second image in this way may include that the non-blank part of the fused image includes the pixel content of the background image and the at least one target display object. Therefore, when the intelligent engine fills the blank part, it may combine the pixel content of the background image and the at least one target display object to fill, such that the filled content, the original background image, and the pixel content of the at least one target display object may be smoothly transitioned to obtain a better visual effect.

In another embodiment, obtaining the second image based on the intelligent engine may include:
inputting the background image as an input image to the intelligent engine first, the intelligent engine processing the background image and filling the blank part according to the pixel content of the non-blank part of the background image to obtain an output image, using the output image as the filled background image, pasting the at least one target display object to the second position of the filled background image, and using the obtained image the second image.

As an example, the background image input to the intelligent engine in the above method may be shown as part (3) of FIG. 4, the obtained filled background image may be shown as part (5) of FIG. 4, and the obtained second image may be shown as part (6) of FIG. 4.

The process of processing the image by the intelligent engine takes a long time. The advantage of obtaining the second image in this way may include that the second image may be obtained by the intelligent engine only processing the pixel content included in the background image, reducing the amount of data that the intelligent engine needs to process, thereby shortening the processing time to a certain extent.

In some other embodiments, filling the background image or the fused image may be achieved without the intelligent engine. For example, the pixel content of the non-blank part of the background image or the fused image may be directly copied and pasted into the blank part of the background image or the fused image to achieve filling.

The benefits of using an intelligent engine for filling may include:
the intelligent engine may be able to analyze the changing patterns of the pixel content in non-blank areas of an image and fill the blank areas based on the analysis results, creating a smoother and more natural transition between the filled pixel content and the original non-blank pixel content, resulting in a better visual effect for the filled image.

In some embodiments, when pasting the at least one target display object to the second position in the background image or the filled background image, a portion of the at least one target display object may extend beyond the edge of the background image or the filled background image. In this case, the portion extending beyond the edge may be cropped, leaving only the portion within the edge of the background image or the filled background image in the second image.

In the aforementioned embodiments, the position of the background image may also be adjusted to a certain extent. In this case, the blank part that may appear after adjusting the background image position may also be filled in the same manner as described above, and will not be further described.

In some optional embodiments, the electronic device may determine the second position by:
obtaining attributes of the at least one target display object; and
determining the second position of the at least one target display object in the target area based on the first condition, the first position, and the attributes of the at least one target display object.

The electronic device may determine the displacement parameter of the at least one target display object based on the first pose and the second pose before and after the change, combined with the attributes of the at least one target display object, and then determine the second position of the at least one target display object based on the first position of the at least one target display object and the displacement parameter of the at least one target display object.

Under the premise of ignoring the influence of the first and second poses before and after the change, the displacement parameter of the at least one target display object may be different depending on the attributes of the at least one target display object. Generally, different displacement amplitudes may be determined depending on the attributes.

As some examples, different displacement parameters may be determined depending on whether the at least one target display object is a person. When the at least one target display object is a person object as shown in part (1) of FIG. 3, a larger displacement amplitude may be determined for the at least one target display object. When the at least one target display object is an object, a smaller displacement amplitude may be determined for the at least one target display object.

As some other examples, different displacement parameters may be determined based on the size of the at least one target display object within the target area. A larger displacement amplitude may be determined for a larger target display object within the target area, while a smaller displacement amplitude may be determined for a smaller target display object.

As some other examples, different displacement parameters may be determined based on the color difference between the at least one target display object and the background image. A smaller displacement amplitude may be determined for a target display object with colors similar to the background image, while a larger displacement amplitude may be determined for a target display object with colors significantly different from the background image.

After determining the displacement parameters, determining the second position based on the displacement parameter and the first position may be similar to the previous embodiments and will not be further described.

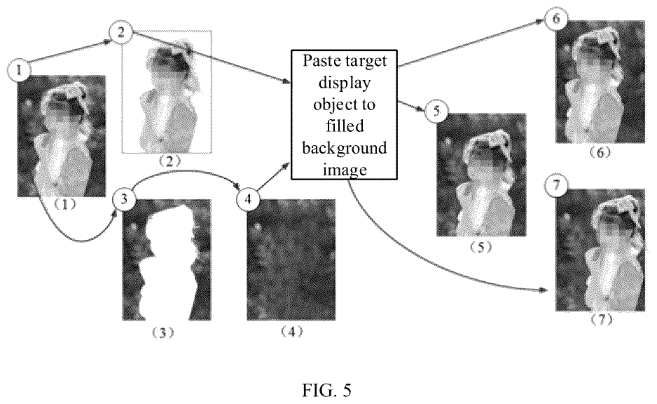

As an example, as shown in FIG. 5, as described in S101, the electronic device may display the first image shown in part (1) of FIG. 5 in the display area of the display screen.

The electronic device may be shaken by the user. If, as described in S102, the electronic device determines that the first condition is satisfied after the shaking, the first image may be cropped to obtain the at least one target display object shown in part (2) of FIG. 5 and the background image shown in part (3) of FIG. 5. The electronic device may process the background image using an intelligent engine to obtain the filled background image shown in part (4) of FIG. 5.

If the user shakes the electronic device by rotating the top of the display screen toward the user, the electronic device may determine the second position below the original first position, and then obtain and display the second image shown in part (5) of FIG. 5 in the display area of the display screen in the manner of the aforementioned embodiments. Compared with part (1) of FIG. 5, as can be seen from part (5) of FIG. 5, the at least one target display object moves downward from the first position.

When the user shakes the electronic device by swinging the display screen to the right, the electronic device may determine the second position located to the left of the original first position, and then obtain and display the second image shown in part (6) of FIG. 5 in the display area of the display screen in the manner of the aforementioned embodiments. By comparing part (1) of FIG. 5 and part (6) of FIG. 5, it can be seen that the at least one target display object moves to the left from the first position.

When the user shakes the electronic device by swinging the display screen to the left, the electronic device may determine the second position located to the right of the original first position, and then obtain and display the second image shown in part (7) of FIG. 5 in the display area of the display screen in the manner of the aforementioned embodiments. By comparing part (1) of FIG. 5 and part (7) of FIG. 5, it can be seen that the at least one target display object moves to the right from the first position.

In some embodiments, after the electronic device displays the at least one target display object based on the target area and the second position, it may be restored to displaying the at least one target display object based on the target area and the first position after a certain period of time.

In combination with the above examples, when the electronic device determines that the first condition is met, it may display the second image shown in part (7) of FIG. 5. After 5 seconds of display, the electronic device may be restored to displaying the first image shown in part (1) of FIG. 5.

In some embodiments, after the electronic device displays the at least one target display object based on the target area and the second position, it may continue to display the at least one target display object based on the second position until the electronic device is restored to the state before the first condition is met, for example, until the electronic device is restored to the pose before the first condition is met.

In some optional embodiments, the target area may include multiple display objects. In this case, the electronic device may determine the at least one target display object from the multiple display objects in at least one of the following determination methods.

In a determination method 1, a display object of a target type among the multiple display objects included in the target area may be determined as the at least one target display object.

In a determination method 2, a selected display object among the multiple display objects included in the target area may be determined as the at least one target display object according to the selection operation.

In a determination method 3, the at least one target display object among the multiple display objects may be determined according to areas occupied by the multiple display objects included in the target area.

For example, in the determination method 1, the electronic device may determine that human-type display objects within the target area are the at least one target display object, and display objects of non-human types may not be determined as target display object. As another example, the electronic device may determine display objects of movable types within the target area, such as display objects of vehicles, humans, or animals, as the at least one target display object, and display objects of immovable types, such as display objects of trees or buildings, are may not be determined as target display objects.

In the determination method 2, the electronic device may prompt the user to select from the multiple display objects and then, based on the user's selection, determine the selected display object as the at least one target display object.

In the determination method 3, the electronic device may select as the at least one target display object any display object in the target area whose area is larger than a certain threshold or first few display objects with the largest area. The electronic device may also select as the at least one target display object any display object in the target area whose area is less than a certain threshold or the first few display objects with the smallest area. The electronic device may also select as the at least one target display object any display object whose area in the target area is within a specific range.

In some other embodiments, the electronic device may sequentially display multiple frames of the first image in the target area at a certain display frequency (e.g., a video frame rate) at multiple consecutive moments in time. Each frame of the first image may include at least one target display object. Correspondingly, the first position may include the first position of the at least one target display object in the target area at multiple consecutive moments in time. In this case, the moment at which the electronic device meets the first condition may be determined as the target moment.

For example, the electronic device may play a video within a target area. Each frame of the video may be considered a first image. When the electronic device determines at time T0 that the first condition is satisfied, time T0 may be designated as the target moment, and a frame of the video played at T0 may be designated as the first image corresponding to the target moment. The time after T0 may be designated as a non-target moment, and frames of the video intended for playback at the non-target moment may be designated as the first images corresponding to the non-target moment.

In one first image corresponding to the non-target moment, the position of the at least one target display object may be designated as the first position corresponding to the non-target moment.

For the scenario in which the electronic device displays multiple consecutive frames of the first image, one display method may include that:
the electronic device may display the at least one target display object based on the target area and a second position corresponding to the target moment, where the second position corresponding to the target moment is obtained based on the first position at the target moment.

The display method may include: the electronic device obtains the first image at the target moment, processes the first image in accordance with the aforementioned embodiments to obtain the second image at the target moment, and then displays the second image at the target moment. In the second image at the target moment, the at least one target display object may be located at the second position corresponding to the target moment. The method for obtaining the second position corresponding to the target moment based on the first position at the target moment may be found in the aforementioned embodiments for obtaining the second position based on the first position, and is not further described.

After displaying the second image at the target moment, the electronic device may display the at least one target display object based on the target area and the first position corresponding to the non-target moment.

In the above embodiments, the electronic device may display the second image continuously for a certain duration, such as one second, two seconds, or another duration, and then begin displaying the first images at the non-target moments one by one at the original display frequency.

Alternatively, in another embodiment, the electronic device may continue to display the second image, pause displaying the first images at subsequent non-target moments, and then, after receiving relevant user input, begin displaying the first images at the non-target moments one by one at the original display frequency.

Based on the above display method, when continuously displaying multiple frames of first images, the electronic device may adjust the position of the at least one target display object in the first image being displayed only when the first condition is determined to be met, and then display the adjusted second image. Subsequent first images may not be adjusted, and the at least one target display object in the subsequent first images may continue to be displayed at the original position.

For the scenario described above where the electronic device displays multiple consecutive frames of the first image, another display method may include:
at each moment, the electronic device displays the at least one target display object based on the second position of the target area corresponding to the moment, where the second position corresponding to the moment is obtained based on the first position at the moment.

In this display method, the electronic device may process the first images at the target moment and each non-target moment after the target moment in the manner described in the preceding embodiments to obtain the second images at the target moment and each non-target moment after the target moment. Then, starting from the target moment, the electronic device may continue to display each frame of the second image at the previous display frequency.

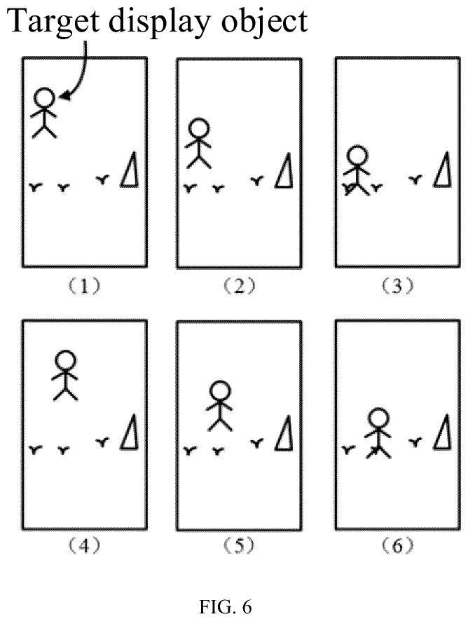

As an example, when the first condition is not satisfied, the electronic device may sequentially display the three frames of first images shown in part (1) of FIG. 6, part (2) of FIG. 6 and part (3) of FIG. 6 at times T0, T1 and T2. Assuming that the electronic device determines that the first condition is satisfied at the time T0, the three frames of first images may be processed according to the method of the aforementioned embodiments to adjust the position of the at least one target display object in each frame of the first image to the second position at the corresponding time. For example, the at least one target display object in each frame of the first image may be moved rightward from the original first position to the second position. Then, the electronic device may sequentially display the three frames of second images shown in part (4) of FIG. 6, part (5) of FIG. 6 and part (6) of FIG. 6. part (4) of FIG. 6 may be obtained by adjusting the position of part (1) of FIG. 6, part (5) of FIG. 6 may be obtained by adjusting the position of part (2) of FIG. 6, and part (6) of FIG. 6 may be obtained by adjusting the position of part (3) of FIG. 6.

When the first image at a certain moment does not include the at least one target display object, the first image at that moment may not be adjusted.

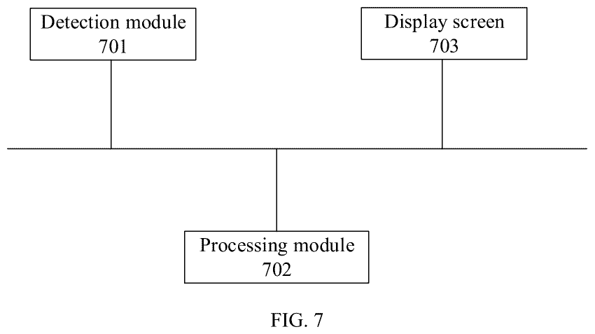

The present disclosure also provides an electronic device. As shown in FIG. 7, in one embodiment, the electronic device may include a detection module 701, a processing module 702, and a display screen 703.

The detection module 701 may be configured to detect whether the electronic device satisfies a first condition.

The processing module 702 may be configured to: obtain a first position of at least one target display object within a target area of display screen 703; when the detection module determines that the electronic device satisfies the first condition, determine a second position of the at least one target display object within the target area based on the first condition and the first position, where the first position and the second position are different, and the first condition includes at least a pose change condition; and display the at least one target display object on display screen 703 based on the target area and the second position.

The detection module may include at least one or more modules capable of detecting the pose of the electronic device, such as a gyroscope, a velocity sensor, or an accelerometer. It may also include a light sensor for detecting ambient brightness, a humidity sensor for detecting ambient humidity, a temperature sensor for detecting ambient temperature, and the like, without limitation.

For the operating principle of the electronic device provided in this embodiment, references may be made to the relevant steps of the processing method provided in any embodiments of the present disclosure and will not be further elaborated.

It should also be noted that the apparatus embodiments described above are merely illustrative. The units described as separate components may or may not be physically separate. The components shown as units may or may not be physical units, that is, they may be located in one location or distributed across multiple network units. Some or all of the modules can be selected based on actual needs to achieve the objectives of these embodiments. Furthermore, in the apparatus embodiments drawings provided herein, the connections between modules indicate a communication connection between them, which can be implemented as one or more communication buses or signal lines.

Through the above description of the embodiments, those skilled in the art will clearly understand that the present disclosure can be implemented using software plus necessary general-purpose hardware. Of course, it can also be implemented using specialized hardware, including application-specific integrated circuits, dedicated CPUs, dedicated memories, and dedicated components. Generally speaking, any function performed by a computer program can be easily implemented using the corresponding hardware. Furthermore, the specific hardware structures used to implement the same function can vary, such as analog circuits, digital circuits, or dedicated circuits. In some embodiments, software implementation is often the preferred implementation method. Based on this understanding, the technical solution of the present disclosure or the portion that contributes to the prior art, may be embodied in the form of a software product. This computer software product may be stored on a readable storage medium, such as a computer floppy disk, a USB flash drive, a removable hard drive, a ROM, a RAM, a magnetic disk, or an optical disk, and may include instructions for enabling a computer device (which may be a personal computer, training device, or network device, etc.) to execute the methods provided by any embodiment of the present disclosure.

In the above embodiments, all or part of the methods may be implemented using software, hardware, firmware, or any combination thereof. When implemented using software, all or part of the methods can be implemented in the form of a computer program product. The various embodiments of the present disclosure are described in a progressive or parallel manner, with each embodiment focusing on the differences from other embodiments. Similar or identical portions between the various embodiments can be referenced separately. As for the devices and electronic devices disclosed in the embodiments, since they correspond to the methods disclosed in the embodiments, the description is relatively simple. For relevant details, references may be made to the method embodiments.

In the present disclosure, relational terms such as first, second, third or fourth are used only to distinguish one entity or operation from another entity or operation, and do not necessarily require or imply any such actual relationship or order between these entities or operations. Further, the terms “comprises”, “including” or any other variations thereof are intended to cover non-exclusive inclusion, so that a process, method, article or apparatus including a series of elements includes not only those elements, but also other elements not explicitly listed, or elements inherent to such process, method, article or apparatus. In the absence of further limitations, an element defined by the phrase “including a . . . ” does not exclude the presence of additional identical elements in the process, method, article or apparatus including the element.

The above describes in detail a plurality of embodiments of the present disclosure, but the present disclosure is not limited to these specific embodiments. Those skilled in the art can make various variations and modifications based on the concept of the present disclosure, and these variations and modifications shall fall within the scope of the present disclosure.

What is claimed is:

1. A processing method comprising:
obtaining a first position of a target display object displayed within a target area;
determining, in response to an electronic device satisfying a condition, a second position of the target display object within the target area based on the condition and the first position, the first position being different from the second position, and the condition including a pose change condition; and
displaying the target display object based on the target area and the second position.

2. The method according to claim 1, wherein determining the second position includes:
determining a displacement parameter of the target display object based on a first pose of the electronic device before pose change and a second pose of the electronic device after the pose change; and
determining the second position based on the displacement parameter and the first position.

3. The method according to claim 1, wherein displaying the target display object includes:
cropping a first image to obtain the target display object included in the first image and a background image of the first image excluding the target display object;
processing the target display object and the background image according to the second position to obtain a second image including the target display object; and
displaying the second image in the target area.

4. The method according to claim 3, wherein:
processing the target display object and the background image includes processing the target display object and the background image according to an intelligent engine and the second position to obtain the second image;
the intelligent engine is configured to determine an output image based on a part of an input image, the part including at least pixel content of the background image; and
the input image is the background image or a fused image obtained by fusing the target display object and the background image according to the second position.

5. The method according to claim 1, wherein determining the second position includes:
obtaining an attribute of the target display object; and
determining the second position based on the condition, the first position, and the attribute.

6. The method according to claim 1, further comprising:
determining a display object of a target type among a plurality of display objects included in the target area as the target display object.

7. The method according to claim 1, further comprising:
determining, based on a selection operation, a display object selected from a plurality of display objects included in the target area as the target display object.

8. The method according to claim 1, further comprising:
determining the target display object from a plurality of display objects based on areas occupied by the plurality of display objects included in the target area.

9. The method according to claim 1, wherein:
the first position is a target first position among a plurality of first positions of the target display object in the target area during a plurality of consecutive moments, the target first position being a position of the target display object at a target moment at which the electronic device satisfies the condition;
the second position is a target second position corresponding to the target moment and is obtained based on the target first position; and
displaying the target display object includes displaying the target display object based on the target area and the target second position.

10. The method according to claim 1, further comprising:
displaying the target display object based on the target area and one of the plurality of first positions corresponding to one of the plurality of consecutive moments other than the target moment.

11. The method according to claim 1, wherein:
the first position is one of a plurality of first positions of the target display object in the target area during a plurality of consecutive moments; and
displaying the target display object includes, at each of the plurality of consecutive moments, displaying the target display object based on the target area and the second position corresponding to the moment that is obtained based on the first position corresponding to the moment.

12. The method according to claim 1, wherein:
the target display object, when displayed based on the first position, is at a first relative position relative to a background image excluding the target display object in an image displayed in the target area;
the target display object, when displayed based on the second position, is at a second relative position relative to the background image; and
the first relative position and the second relative position are different from each other.

13. The method according to claim 1, further comprising:
adjusting, in response to the electronic device satisfying the condition, a position of a background image of the first image excluding the target display object to an adjusted position;
wherein:
an amplitude of a position adjustment of the background image is different from an amplitude of a position adjustment of the target display object; and
displaying the target display object includes displaying, in the target area, the target display object at the second position and the background image at the adjusted position.

14. An electronic device comprising:
a display screen;
a detection module configured to detect whether the electronic device satisfies a condition; and
a processing module configured to:
obtain a first position of a target display object displayed within a target area of the display screen;
determine, in response to the electronic device satisfying a condition, a second position of the target display object within the target area based on the condition and the first position, the first position being different from the second position, and the condition including a pose change condition; and
display the target display object based on the target area and the second position.

15. The electronic device according to claim 14, wherein the processing module is further configured to, when determining the second position:
determine a displacement parameter of the target display object based on a first pose of the electronic device before pose change and a second pose of the electronic device after the pose change; and
determine the second position based on the displacement parameter and the first position.

16. The electronic device according to claim 14, wherein the processing module is further configured to, when displaying the target display object:
crop a first image to obtain the target display object included in the first image and a background image of the first image excluding the target display object;
process the target display object and the background image according to the second position to obtain a second image including the target display object; and
display the second image in the target area.

17. The electronic device according to claim 16, wherein:
the processing module is further configured to, when processing the target display object and the background image, process the target display object and the background image according to an intelligent engine and the second position to obtain the second image;
the intelligent engine is configured to determine an output image based on a part of an input image, the part including at least pixel content of the background image; and
the input image is the background image or a fused image obtained by fusing the target display object and the background image according to the second position.

18. The electronic device according to claim 14, wherein the processing module is further configured to, when determining the second position:
obtain an attribute of the target display object; and
determine the second position based on the condition, the first position, and the attribute.

19. The electronic device according to claim 14, wherein the processing module is further configured to:
determine a display object of a target type among a plurality of display objects included in the target area as the target display object.

20. A non-transitory computer-readable storage medium storing program instructions that, when executed by a processor, cause an electronic device including the processor to:
obtain a first position of a target display object displayed within a target area;
determine, in response to the electronic device satisfying a condition, a second position of the target display object within the target area based on the condition and the first position, the first position being different from the second position, and the condition including a pose change condition; and
display the target display object based on the target area and the second position.
